(19) United States
(12) Patent Application Publication
(10) Pub. No.: US 2007/0247396 A1
(43) Pub. Date: Oct. 25, 2007

(54) Plasma display apparatus and driving method thereof

(75) Inventor: Byung Nam Ahn, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/785,681

(22) Filed: Apr. 19, 2007

(30) Foreign Application Priority Data
Apr. 19, 2006 (KR) 10-2006-0035442
Apr. 27, 2006 (KR) 10-2006-0037969

(51) Int. Cl. G09G 3/28

(52) U.S. Cl. 345/60

(57) ABSTRACT

A plasma display apparatus comprises a plasma display panel and a driver. The plasma display panel includes a first electrode and a second electrode. The driver makes a voltage difference between the first electrode and the second electrode gradually rise from a magnitude of a first voltage to a sum of magnitudes of the first voltage and a second voltage by supplying a first pulse and a second pulse respectively to the first electrode and the second electrode during a reset period, and supplying a sustain pulse swinging from a positive sustain voltage to a negative sustain voltage to the second electrode during a sustain period.

This application claims the benefit of Korean Patent Application No. 10-2006-0035442 and 10-2006-0037969 filed on Apr. 19, 2006 and Apr. 27, 2006, which is hereby incorporated by reference.

### BACKGROUND

1. Field

This document is related a plasma display apparatus and a driving method of the plasma display apparatus.

2. Description of the Related Art

A plasma display apparatus includes a plasma display panel and a driver. The plasma display panel includes a discharge cell partioned by a barrier rib. The driver supplies a driving signal to an electrode of the plasma display panel. As a result of a supply of the driving signal, a discharge occurs in the discharge cell, and excites a phosphor of the discharge cell. When the discharge excites the discharge cell, the phosphor generates light.

The plasma display apparatus achieves grey levels with a combination of subfields. The plasma display apparatus emits light during each subfield, and the grey levels are achieved by a sum of light amount emitted during each subfield.

Each subfield includes a reset period, an address period, and a sustain period. During the reset period, wall discharges of entire discharge cells of the plasma display panel are uniformed. Some discharge cells of the entire discharge cells are selected during the address period. The selected discharge cells emit light during the sustain period.

### SUMMARY

In one aspect, a plasma display apparatus comprises a plasma display panel including a first electrode and a second electrode, and a driver making a voltage difference between the first electrode and the second electrode gradually rise from a magnitude of a first voltage to a sum of magnitudes of the first voltage and a second voltage by supplying a first pulse and a second pulse respectively to the first electrode and the second electrode during a reset period, and supplying a sustain pulse swinging from a positive sustain voltage to a negative sustain voltage to the second electrode during a sustain period.

The driver may include a first electrode driver supplying to the first electrode the first pulse gradually rising from a reference voltage to the second voltage during the reset period and the reference voltage during the sustain period, and a second electrode driver supplying to the second electrode the second pulse falling from the reference voltage to the first voltage during the reset period and the sustain pulse swinging from the positive sustain voltage to the negative sustain voltage during the sustain period.

The first electrode driver may include a drive IC connected to the first electrode and a switch supplying the first pulse through the drive IC.

The first electrode driver may include a drive IC connected to the first electrode and a switch supplying a third pulse gradually falling from the reference voltage to a third voltage through the drive IC.

The first electrode driver may include a drive IC connected to the first electrode and a switch supplying a scan reference voltage during an address period through the drive IC.

The scan reference voltage may be substantially equal to a ground level voltage.

The first electrode driver may include a drive IC connected to the first electrode and a switch supplying a scan pulse falling a fourth voltage during an address period through the drive IC.

The first electrode driver may include a drive IC connected to the first electrode, a switch connected to one terminal of the drive IC, a second voltage source, which is connected to the other terminal of the drive IC and the switch, supplying the second voltage, a first ground switch connected to the one terminal of the drive IC and a ground, and a second ground switch connected to the other terminal of the drive IC and the ground.

The switch may operate in an active region during a reset period, and the drive IC may supply a pulse gradually rising from a ground level voltage to the second voltage to the first electrode when the second ground switch is turned on.

The switch may operate in an active region during a reset period, and the drive IC may supply a pulse falling from a ground level voltage to the first electrode when the first ground switch is turned on.

The switch may operate in a saturation region during an address period, and the drive IC may supply a scan pulse falling to the second voltage to the first electrode when the first ground switch is turned on.

The driver may include a first electrode driver supplying to the first electrode the firs pulse rising from a reference voltage to the second voltage during the reset period, and the reference voltage during the sustain period, and a second electrode driver supplying to the second electrode the second pulse gradually falling from the reference voltage to the first voltage and the sustain pulse during the sustain period.

The first electrode driver may include a drive IC, a second voltage source connected to the drive IC and supplying the second voltage, and a switch, which is connected to the second voltage source, supplying the first pulse and the reference voltage at the time of a supply of the sustain pulse.

The first electrode driver may include a drive IC connected to the first electrode and a switch supplying a third pulse gradually falling to a third voltage during the reset period through the drive IC.

The first electrode driver may include a drive IC connected to the first electrode, and a switch supplying a scan pulse falling to a fourth voltage during an address period.

The first electrode driver may include a drive IC connected to the first electrode, a second voltage source, which is connected to the drive IC, supplying the second voltage, a fourth voltage source supplying a fourth voltage, and a switch supplying a sum of the second voltage and the fourth voltage during an address period through the drive IC.

In another aspect, a driving method of a plasma display apparatus including a first electrode and a second electrode, comprises making a voltage difference between the first electrode and the second electrode gradually rise from a magnitude of a first voltage to a sum of magnitudes of the first voltage and a second voltage by supplying a first pulse and a second pulse respectively to the first electrode and the second electrode during a reset period and supplying a sustain pulse swinging from a positive sustain voltage to a negative sustain voltage during a sustain period.

The first pulse, which gradually rises from a reference voltage to the second voltage, may supplied to the first electrode, the reference voltage may be supplied to the first electrode during the sustain electrode, and the second pulse, which falls from the reference voltage to the first voltage, may be supplied to the second electrode.

The first pulse, which rises from a reference voltage to the first voltage, may be supplied to the first electrode, the reference voltage may be supplied to the first electrode during the sustain period, and the second pulse, which gradually falls from the reference voltage to the first voltage, may be supplied to the second electrode.

### BRIEF DESCRIPTION OF THE DRAWINGS

The embodiment will be described in detail with reference to the following drawings.

FIG. 1 illustrates a plasma display apparatus according to an embodiment;

FIG. 2a illustrates an example of driving signal of the plasma display apparatus of the embodiment;

FIG. 2b illustrates a voltage difference between a first electrode and a second electrode according to a supply of a first pulse and a second pulse;

FIG. 3 illustrates an example of a driver supplying the driving signal of FIG. 2a;

FIGS. 4a to 4d illustrate an operation of the driver of FIG. 3;

FIG. 5 illustrates another example of the driver supplying the driving signal of FIG. 2a;

FIGS. 6a to 6d illustrate an operation of the driver of FIG. 5;

FIG. 7 illustrates a disposition of a driving board;

FIG. 8a illustrates another example of the driving signal of the plasma display apparatus of the embodiment;

FIG. 8b illustrates a voltage difference between the first electrode and the second electrode according to the first pulse and the second pulse;

FIG. 9 illustrates another example of the driver supplying driving signal of FIG. 8a; and

FIGS. 10a to 10d illustrate an operation of the driver of FIG. 9.

### DETAILED DESCRIPTION OF EMBODIMENTS

Embodiments will be described in a more detailed manner with reference to the drawings.

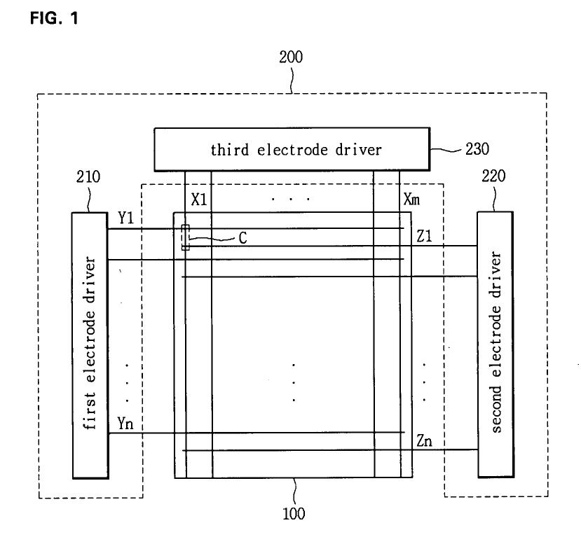

FIG. 1 illustrates a plasma display apparatus according to an embodiment. As illustrated in FIG. 1, the plasma display apparatus according to the embodiment includes a plasma display panel 100 and a driver 200. The driver 200 includes a first electrode driver 210, a second electrode driver 220 and a third electrode driver 230.

The plasma display panel 100 includes a first electrode Y1-Yn, a second electrode Z1-Zn and a third electrode X1-Xm. The first electrode Y1-Yn is parallel with the second electrode Z1-Zn, and the third electrode X1-Xm crosses the first electrode Y1-Yn and the second electrode Z1-Zn. An area where the third electrode X1-Xm crosses the first electrode Y1-Yn and the second electrode Z1-Zn corresponds to a discharge cell.

The driver 200 respectively supplies a first pulse and a second pulse to the first electrode Y1-Yn and the second electrode Z1-Zn during a reset period. The first electrode driver 210 of the driver 200 supplies the first pulse to the first electrode Y1-Yn, and the second electrode driver 210 of the driver 200 supplies the second pulse to the second electrode Z1-Zn. As a result of supply of the first pulse and the second pulse, a voltage difference between the first electrode Y1-Yn and the second electrode Z1-Zn gradually rises from a magnitude of a first voltage to a sum of magnitudes of the first voltage and a second voltage. Due to the voltage difference generated by the supply of the first pulse and the second pulse, wall charges of all discharge cells of the plasma display panel 100 are uniformed. The first electrode driver 210 of the driver 200 supplies scan pulses to the first electrodes Y1-Yn during an address period sequentially, and the third electrode driver 230 supplies data pulses synchronized with the scan pulses to the third electrodes X1-Xm. The driver 200 supplies a sustain pulse swinging from a positive sustain voltage to a negative sustain voltage to the second electrode during a sustain period.

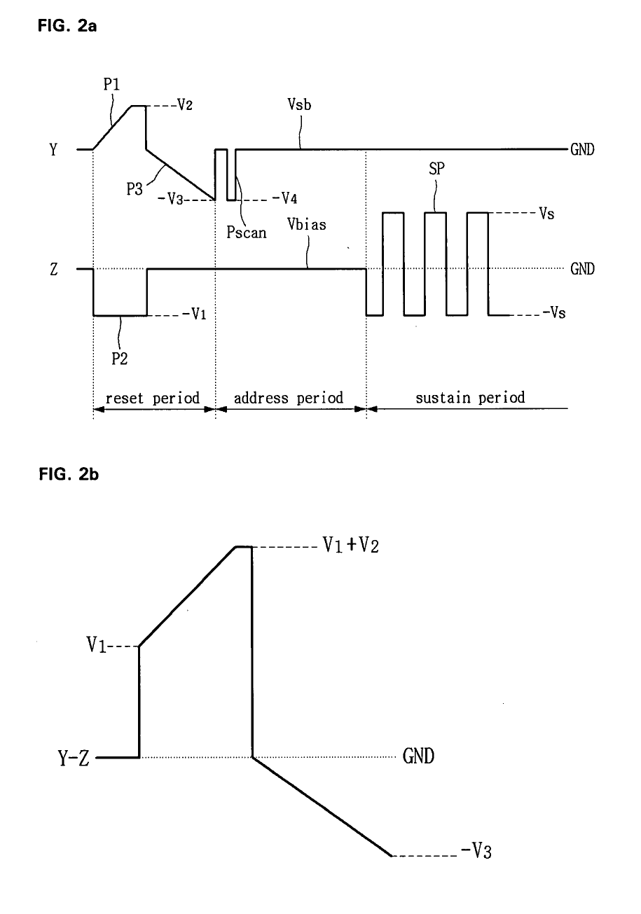

FIG. 2a illustrates an example of driving signal of the plasma display apparatus of the embodiment. As illustrated in FIG. 2a, the first electrode driver 210 of the driver 200 supplies to the first electrode Y the first pulse P1 gradually rising from a reference voltage to the second voltage V2 during the reset period. After a supply of the first pulse P1, the first electrode driver 210 supplies a third pulse P3 gradually falling from the reference voltage to a third voltage to the first electrode Y. The first electrode driver 210 supplies a scan pulse Pscan falling a scan reference voltage Vsb to a fourth voltage −V4 to the first electrode Y during an address period. After or before a supply of the scan pulse Pscan, the first electrode driver 210 supplies the scan reference voltage Vsb to the first electrode Y. As illustrated in FIG. 2a, the scan reference voltage Vsb may be the ground level voltage GND or a voltage lower than the ground level voltage GND. The first electrode driver 210 supplies the reference voltage during a sustain period. The reference voltage may be a ground level voltage GND.

The second electrode driver 220 supplies to the second electrode Z the second pulse P2 falling from the reference voltage to the first voltage −V1 during the reset period. The second electrode driver 220 supplies a sustain bias voltage Vbias to the second electrode Z during the address period. The second electrode driver 220 supplies the sustain pulse SP swinging from the positive sustain voltage Vs to the negative sustain voltage −Vs to the second electrode Z during the sustain period. The sustain pulse SP generates sustain discharge in a discharge cell selected by the scan pulse Pscan and the data pulse.

As a result of the supply of the first pulse P1 and the second pulse P2, the voltage difference between the first electrode Y and the second electrode Z, as illustrated in FIG. 2b, gradually rises from a magnitude of the first voltage −V1 to a sum V1+V2 of magnitudes of the first voltage −V1 and the second voltage V2.

Due to the supply of the first pulse P1 rising to the second voltage V2 and the second pulse P2 falling to the first voltage −V1, the wall charges of the discharge cells are uniformed. Accordingly, the driver 200 has low withstanding characteristic. A manufacture cost of the driver 200 decreases, and an interference and a distortion of driving signal are reduced.

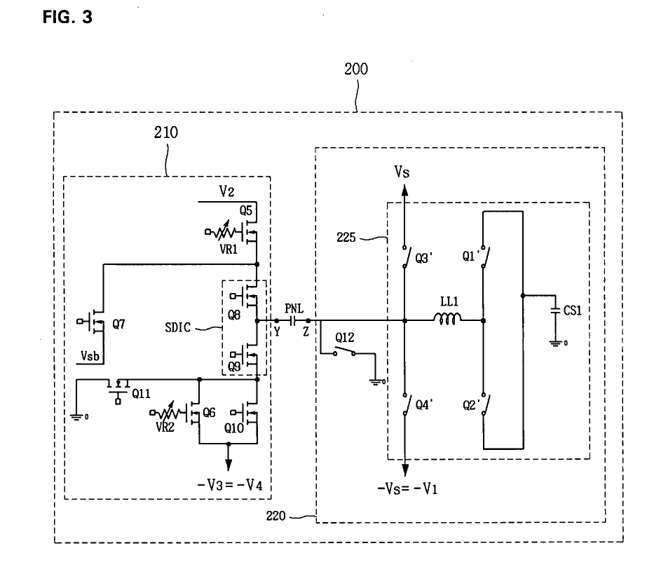

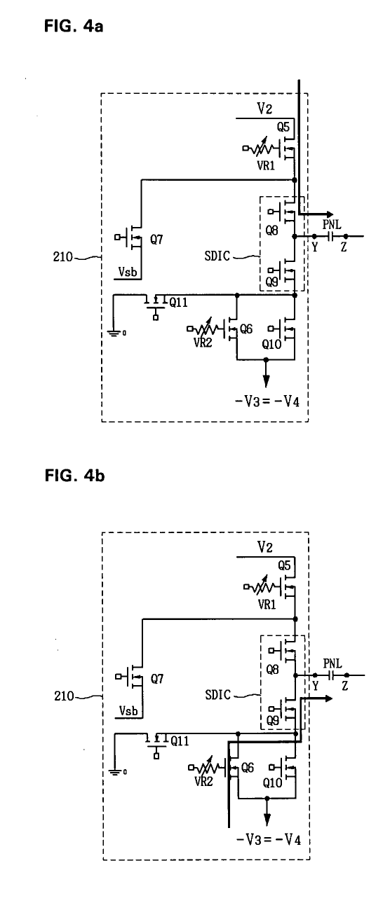

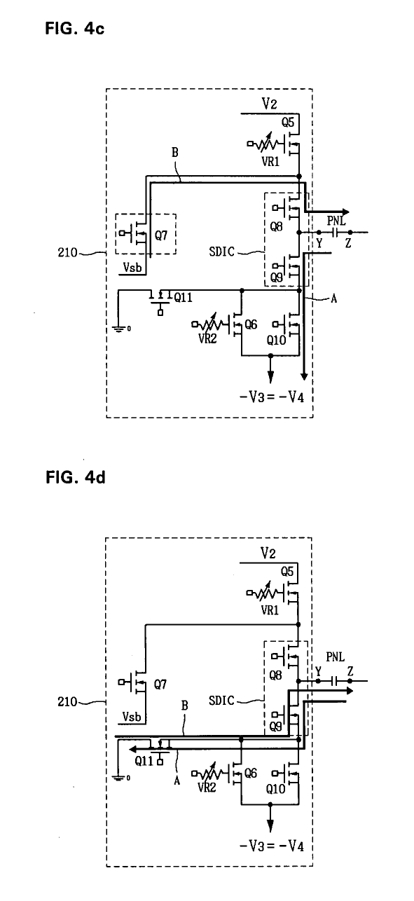

FIG. 3 illustrates an example of a driver supplying the driving signal of FIG. 2a. FIGS. 4a to 4d illustrate an operation of the driver of FIG. 3. As illustrated in FIG. 3, the driver 200 includes the first electrode 210 and the second electrode driver 220. The first electrode driver 210 and the second electrode driver 220 are connected to the first electrode Y and the second electrode Z of the plasma display panel PNL.

A drive IC SDIC of the first electrode driver 210 includes a switch Q8 and a switch Q9, of which a common node is connected to the first electrode Y, supplies a driving signal to the first electrode Y.

A switch Q5 of the first electrode driver 210 supplies the first pulse of FIG. 2a through the drive IC SDIC. A slope of the first pulse P1 varies according to a resistance of a variable resistor VR1 connected to the switch Q5. One terminal of the switch Q5 is connected to the switch Q8 of the drive IC SDIC. When the switches Q5 and Q8 are turned on, a current path for a supply of the first pulse P1 is formed.

During the supply of the first pulse P1, a switch Q4 of the second electrode driver 220 is turned on, and the second pulse P2 is supplied. As illustrated in FIG. 3, the first voltage −V1 may be the negative sustain voltage −Vs. In case that the first voltage −V1 is different from the negative sustain voltage −Vs, the second electrode driver 220 may further include another switch for supplying the first voltage −V1.

After the supply of the first pulse P1, a switch Q6 of the first electrode driver 210 supplies to the first electrode Y a third pulse P3 gradually falling from the reference voltage to a third voltage −V3 through the drive IC SDIC. A slope of the third pulse P3 varies according to a resistance of a variable resistor connected to the switch Q6. One terminal of the switch Q6 is connected to the switch Q9 of the drive IC. When the third pulse P3 is supplied, a switch Q12 of the second electrode driver 220 is turned on, and the reference voltage is supplied to the second electrode Z. A current path for the supply of the third pulse P3 is illustrated in FIG. 4b.

After the supply of the third pulse P3, a switch Q7 of the first electrode driver 210 supplies to the first electrode Y a scan reference voltage Vsb of FIG. 2a during the address period through the drive IC SDIC. One terminal of the switch Q7 is connected to a common node of the switch Q5 and the drive IC SDIC. As described with reference to FIG. 2a above, the scan reference voltage Vsb may substantially be the same as the ground level voltage, or may be different from the ground level voltage. In the case that the scan reference voltage Vsb is substantially the same as the ground level voltage, the switch Q11 may supply the scan reference voltage Vsb of the ground level voltage to the first electrode Y through the drive IC SDIC. The switch Q11 is connected to the switch Q9 of the drive IC SDIC.

A switch Q10 of the first electrode driver 210 supplies the scan pulse Pscan of FIG. 2a falling a fourth voltage during an address period through the drive IC SDIC. The switch Q10 is connected to the switch Q9 of the drive IC SDIC.

A current path A for supply the scan pulse and a current path B for supplying the scan reference voltage are illustrated in FIG. 4c.

During the address period, the switch Q12 of the second electrode driver 220 supplies the reference voltage to the second electrode Z by maintaining a turn-on state.

The switch Q11 supplies the reference voltage to the first electrode Y during the sustain period. An energy recovery circuit 225 of the second electrode driver 220 generates a sustain discharge by a supply of a sustain pulse swinging from a positive sustain voltage Vs to a negative sustain voltage −Vs. FIG. 4d illustrates current paths generated by the sustain pulse.

A switch Q4 of the energy recovery circuit 225 of FIG. 3 is turned on, and the rest switches Q1, Q2 and Q3 are turned off. Accordingly, the negative sustain voltage −Vs is supplied to the second electrode Z.

A switch Q1 is turned on, and the rest switches Q2, Q3 and Q4 are turned off. Energy is recovered from the second electrode Z and an inductor LL1 to a capacitor CS1 through a resonance state. Accordingly, a voltage of the second electrode Z rises from the negative sustain voltage −Vs to the positive sustain voltage Vs. A voltage between both terminals of the capacitor CS1 recovering the energy is substantially equal to 0V, because the voltage between both terminals of the capacitor CS1 recovering the energy is 0.5 time of a sum of the negative sustain voltage −Vs and the positive sustain voltage Vs.

A switch Q3 is turned on, and the rest switches Q1, Q2 and Q4 are turned off. Accordingly, the positive sustain voltage Vs is supplied to the second electrode Z.

A switch Q2 is turned on, and the rest switches Q1, Q3 and Q4 are turned off. Energy is supplied from the capacitor CS1 to the inductor LL1 and the second electrode Z through a resonance state. Accordingly, a voltage of the second electrode Z falls from the positive sustain voltage Vs to the negative sustain voltage −Vs.

As described with reference to the above figures, the first electrode driver and the second electrode driver of the driver uniforms wall charges of the discharge cells by supplying the first pulse and the second pulse. Because the first electrode driver does not an energy recovery circuit, the second electrode driver generates a sustain discharge by supplying the sustain pulse swinging from the positive sustain voltage and the negative sustain voltage. Accordingly, a structure of the driver is simple, a manufacture cost of the driver and a distortion of a driving signal are reduced.

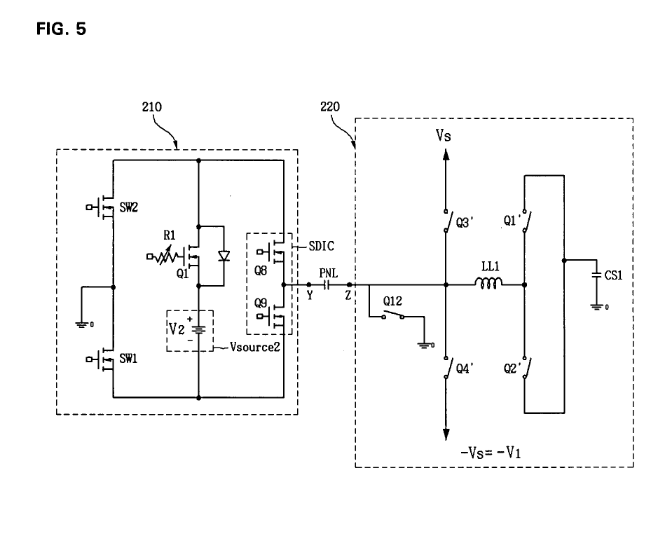

FIG. 5 illustrates another example of the driver supplying the driving signal of FIG. 2a. The driver of FIG. 5 includes a first electrode driver 210 and a second electrode driver 220. A structure and an operation of the second electrode driver 220 of FIG. 5 is the same as the structure and the operation of the second electrode driver 220 of FIG. 3, thus the detailed description of the structure and an operation of the second electrode driver 220 of FIG. 5 is omitted.

The first electrode driver 210 includes a drive IC SDIC, a switch Q1, a second voltage source Vsource2, a first ground switch SW1, a second ground switch SW2. The drive IC SDIC includes a switch Q8 and a switch Q9 of which a common node is connected to the first electrode Y, and supplies a driving signal to the first electrode Y. The switch Q1 is connected to one terminal of the drive IC SDIC, namely, the switch Q1 is connected to one terminal of the switch Q8. The second voltage source Vsource2, which is connected to the other terminal of the drive IC SDIC and the switch Q1, supplies the second voltage V2. The first ground switch SW1 is connected to the one terminal of the drive IC SDIC and a ground. The second ground switch SW2 is connected to the other terminal of the drive IC SDIC and the ground.

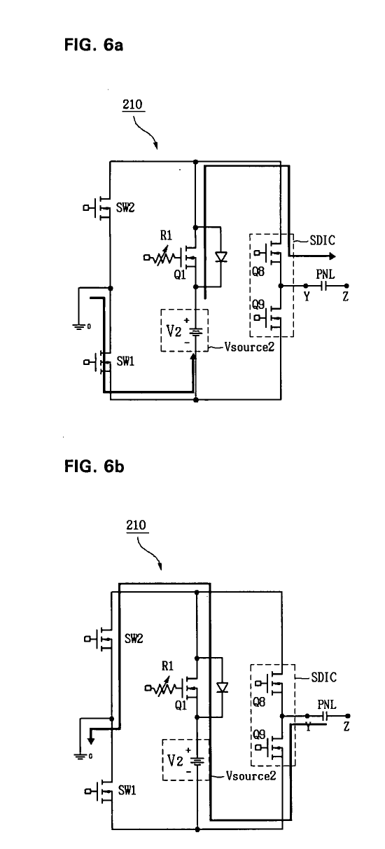

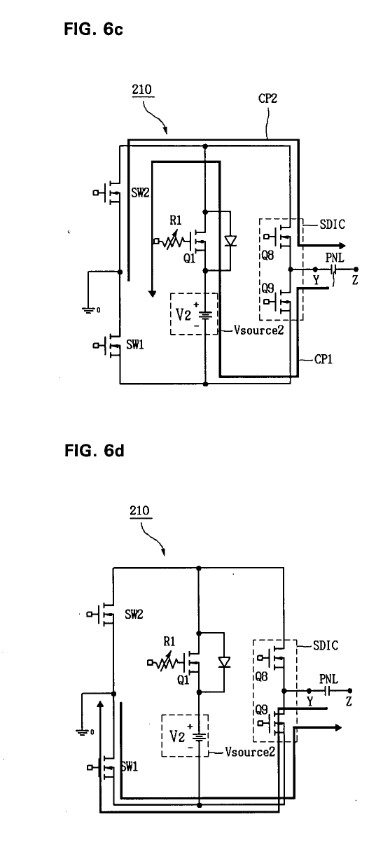

FIGS. 6a to 6d illustrate an operation of the driver of FIG. 5.

During a reset period, the switch Q1 operates in an active region where a Miller capacitor (not shown) discharges, and the second ground switch SW2 and the switch Q8 of the drive IC SDIC are turned on. The drive IC SDIC supplies the first pulse P1 of FIG. 2a gradually rising from a ground level voltage to the second voltage V2 to the first electrode Y. Accordingly, a current path of FIG. 6a is formed.

After the supply of the first pulse P1, the switch Q1 continuously operates in the active region during a reset period. When the first ground switch SW1 and the switch Q9 are turned on, the drive IC supplies the third pulse P3 gradually falling from the ground level voltage to the second voltage −V2 to the first electrode Y. In FIG. 2a, the third pulse P3 falls to the third voltage −V3. In FIG. 6b, the third pulse P3 falls to the second voltage −V2. The third pulse P3 of FIG. 2a is formed by the switch Q6 of FIG. 3 receiving the third voltage −V3. The third pulse P3 of FIG. 6b is formed by the switch Q1 and the second voltage source Vsource2 of FIG. 6b.

After the third pulse P3, the switch Q1 maintains a turn-on state. Accordingly, the switch Q1 operates in an saturation region during an address period. When the first ground switch SW1 and the switch Q9 are turned on, a current path CP1 of FIG. 6c is formed. The drive IC SDIC supplies a scan pulse falling to the second voltage −V2 to the first electrode Y.

When the switch Q1 is turned off and the first ground switch SW1 and the switch Q8 are turned on, a scan reference voltage of the ground level is supplied to the first electrode Y.

When the electrode driver 220 of FIG. 5 supplies the sustain pulse swinging from the positive sustain voltage to the negative sustain voltage, the first ground switch SW1 and the switch Q9 are turned on. Accordingly, the ground level voltage is supplied to the first electrode Y and a current path of FIG. 6a is formed.

A structure of the driver of FIG. 5 is simple because the driver of FIG. 5 supplying a driving signal through the second voltage source Vsource2 and the switch Q1, and two ground switches SW1 and SW2. The simple structure of the driver makes a manufacture cost of the driver decrease. The supply of the sustain pulse by only the second electrode driver makes a distortion of the driving signal decrease.

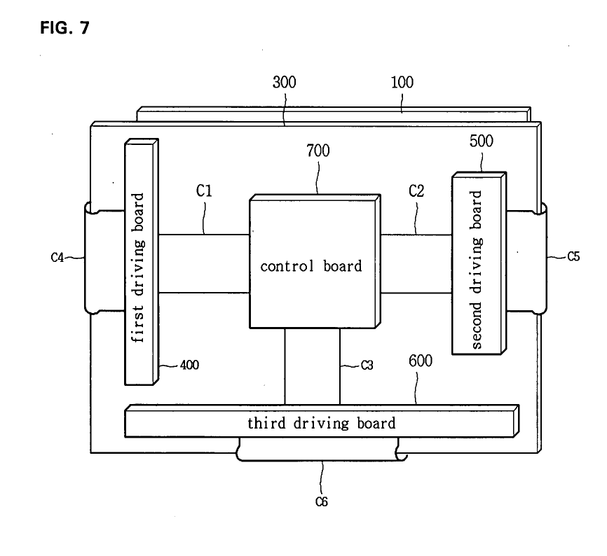

FIG. 7 illustrates a disposition of a driving board. A heat radiation plate 300 emits heat of a plasma display panel 100 by contacting with the plasma display panel. A first driving board 400 of the first electrode driver 210 of FIG. 3 or FIG. 5, a second driving board 500 of the second electrode driver 220 of FIG. 3, a third driving board 600 of the third electrode driver 230 of FIG. 3, and a control board 700, are disposed on the heat radiation plate 300. The control board 700 outputs timing control signals for controlling the first electrode driver 210, the second electrode driver 220 and the third electrode driver 230.

Because the second electrode driver 220 supplies the sustain pulse swinging from the negative sustain voltage to the positive sustain voltage, the first electrode driver does not include a circuit for generating a sustain pulse. The first driving board does not include a board for a generation of the sustain pulse. Accordingly, a structure of the first driving board 400 is simple, and the manufacture cost of the first driving board 400 can be reduced.

C1, C2 and C3 of FIG. 7 are connection units connected to each driving board 400, 500, 600, and 700. C4, C5 and C6 of FIG. 7 are connection units for connections between each driving board 400, 500, and 600, and the first electrode, the second electrode, and the third electrode.

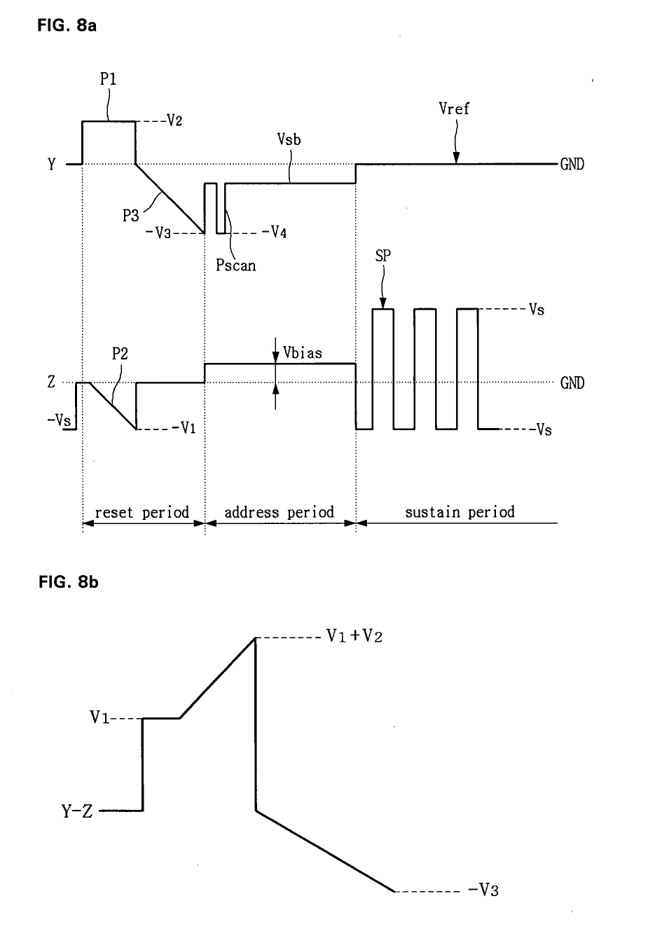

FIG. 8a illustrates another example of the driving signal of the plasma display apparatus of the embodiment.

As illustrated in FIG. 8a, the first electrode driver 210 supplies to the first electrode Y the firs pulse P1 rising from a reference voltage to the second voltage V2 during the reset period. The third pulse P3 supplied by the second electrode driver 210 is the same as the third pulse P3 of FIG. 2a, thus the description of the third pulse P3 being omitted.

The first electrode driver 210 supplies a scan pulse Pscan falling from the scan reference voltage Vsb to the fourth voltage −V4 to the first electrode Y during the address period. The level of the scan reference voltage Vsb may be lower than a ground level. The first electrode driver 210 supplies the reference voltage to the first electrode Y during the sustain period. The reference voltage may be the ground level voltage.

The second electrode driver 220 of the driver 200 supplies to the second electrode Z the second pulse P2 gradually falling from the reference voltage to the first voltage −V1. The second electrode driver 220 may supply a sustain bias voltage Vbias higher than the ground level voltage. The second electrode driver 220 supplies a sustain pulse swinging from a positive sustain voltage Vs to a negative sustain voltage −Vs during the sustain period.

In FIG. 8a, The voltage difference between the first electrode Y and the second electrode Z gradually rises from a magnitude of the first voltage −V1 to a sum of magnitudes of the first voltage −V1 and the second voltage V2.

Because wall charges of discharge cells are uniformed as a result of the supply of the first pulse P1 and the second pulse P2, the driver 200 has a low withstanding voltage, a manufacture cost is reduced, and a distortion and an interference of a driving signal are decreased.

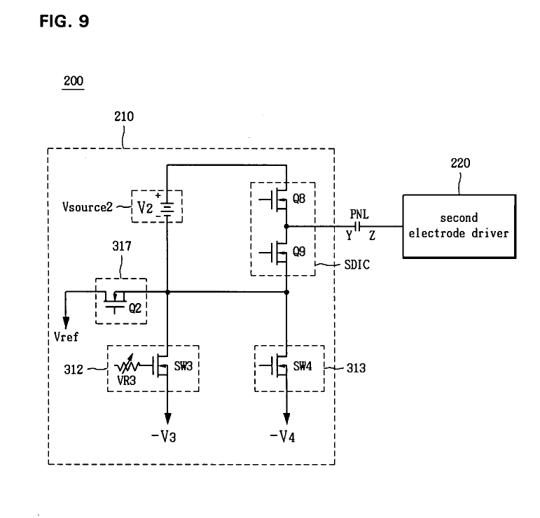

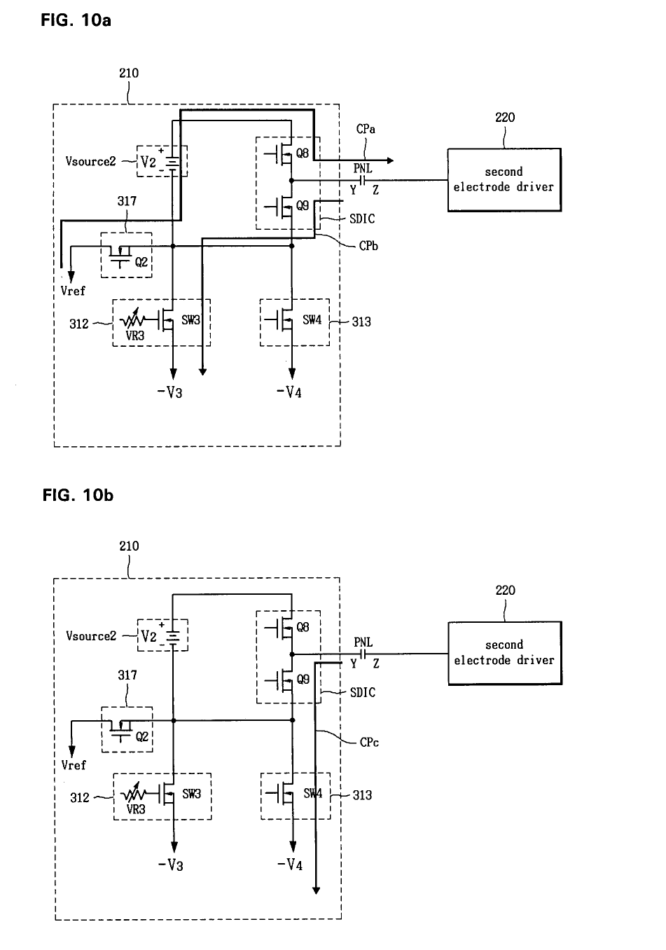

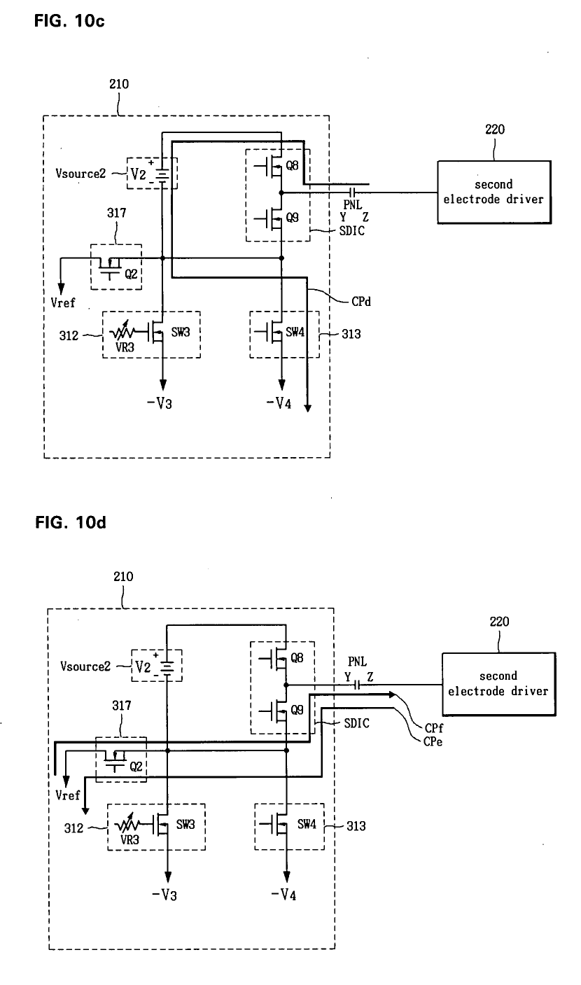

FIG. 9 illustrates another example of the driver supplying driving signal of FIG. 8a. FIGS. 10a to 10d illustrate an operation of the driver of FIG. 9. A structure and an operation of the second electrode driver of FIG. 9 is the same as the structure and the operation of the second electrode driver of FIG. 3, thus a detailed description of the structure and the operation of the second electrode driver of FIG. 9 is omitted.

As illustrated in FIG. 9, the driver 200 includes a first electrode driver 210 and a second electrode driver 220. The first electrode driver 210 and the second electrode driver 220 are respectively to a first electrode Y and a second electrode Z of a plasma display panel PNL.

A drive IC SDIC includes a switch Q8 and a switch Q9, and a common node of the switch Q8 and the switch Q9 is connected to the first electrode Y.

A switch Q2 of the first electrode driver 210 is connected to a second voltage source Vsource2 supplying the second voltage V2, and supplies the reference voltage Vref when the first pulse and the sustain pulse are supplied. The switch Q2 is connected to the switch Q9 of the drive IC SDIC. The reference voltage Vref may be the ground level voltage. When the switch Q2 and the switch Q8 are turned on, a current path CPa of FIG. 10a is formed. Accordingly, the first pulse P1 of FIG. 8a is supplied to the first electrode Y. When the first pulse P1 is supplied, the second electrode driver 220 supplies the second pulse P2 of FIG. 8a to the second electrode Z. As a result of the supply of the first pulse P1 and the second pulse P2, wall charges of discharge cell are uniformed.

After a supply of the first pulse P1, the switch SW3 of the first electrode driver 210 supplies the third pulse P3 gradually falling to the third voltage −V3 during the reset period through the drive IC SDIC. A slope of the third pulse P3 is decided by a variable resistor VR3 connected to the switch Q3. As illustrated in FIG. 10a, when the switch Q9 and the switch Q3 are turned on, a current path CPb for a supply of the third pulse P3 of FIG. 8a is formed. By the third pulse P3, A portion of wall charges formed in the discharge cell are erased. During the supply of the third pulse P3, the second electrode driver 220 may supply a ground level voltage GND. The switch SW3 is connected to a common node of the switch Q2, the second voltage source Vsource2, and the switch Q9.

A switch SW4 of the first electrode driver 210 supplies a scan pulse falling to a fourth voltage −V4 during the address period. As illustrated in FIG. 10b, according to turn-on of the switch SW4 and the switch Q9, a current path CPc is formed. The current path CPc is for the supply of the scan pulse of FIG. 8a to the first electrode Y. When a data pulse, which is not illustrated, synchronised with the scan pulse Pscan is supplied, discharge cell where a sustain discharge will be generated is selected. The switch SW4 is connected to a common node of the switch Q2, the second voltage source Vsource2 and the switch Q9.

A switch SW4 supplies to the first electrode Y a sum of the second voltage V2 of the second voltage source Vsource2 and the fourth voltage −V4 of a fourth voltage source (not shown) during the address period through the drive IC. As illustrated in FIG. 10c, when the switch SW4 and the switch Q8 are turned on, a current path CPd is formed and the second voltage source Vsource2 and the fourth voltage source are connected in serial. Accordingly, the sum of the second voltage V2 and the fourth voltage V4 is supplied to the first electrode Y. The sum of the second voltage V2 and the fourth voltage V4 corresponds to the scan reference voltage Vsb of FIG. 8a.

The second electrode driver 220 supplies the sustain bias voltage Vbias of FIG. 8a during the address period.

As illustrated in FIG. 8a, the second electrode driver 220 supplies the sustain pulse swinging from the positive sustain voltage Vs to the negative sustain voltage −Vs to the second electrode Z during the sustain period. The switch Q2 and the switch Q9 of the first electrode driver 210 are turned on. A current paths CPe and CPf are formed. Accordingly, a sustain discharge is generated in the discharge cell selected during the address period.

As describe above, because the driver supplies the first pulse and the second pulse to the first electrode and the second electrode, a structure of the driver is simple, a withstanding voltage of the driver is low, a manufacture cost of the driver and a distortion of a driving signal are reduced.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus comprising:
a plasma display panel including a first electrode and a second electrode;
a driver making a voltage difference between the first electrode and the second electrode gradually rise from a magnitude of a first voltage to a sum of magnitudes of the first voltage and a second voltage by supplying a first pulse and a second pulse respectively to the first electrode and the second electrode during a reset period, and supplying a sustain pulse swinging from a positive sustain voltage to a negative sustain voltage to the second electrode during a sustain period.

2. The plasma display apparatus of claim 1, wherein
the driver includes a first electrode driver supplying to the first electrode the first pulse gradually rising from a reference voltage to the second voltage during the reset period and the reference voltage during the sustain period, and a second electrode driver supplying to the second electrode the second pulse falling from the reference voltage to the first voltage during the reset period and the sustain pulse swinging from the positive sustain voltage to the negative sustain voltage during the sustain period.

3. The plasma display apparatus of claim 2, wherein
the first electrode driver includes a drive IC connected to the first electrode and a switch supplying the first pulse through the drive IC.

4. The plasma display apparatus of claim 2, wherein
the first electrode driver includes a drive IC connected to the first electrode and a switch supplying a third pulse gradually falling from the reference voltage to a third voltage through the drive IC.

5. The plasma display apparatus of claim 2, wherein
the first electrode driver includes a drive IC connected to the first electrode and a switch supplying a scan reference voltage during an address period through the drive IC.

6. The plasma display apparatus of claim 5, wherein
the scan reference voltage is substantially equal to a ground level voltage.

7. The plasma display apparatus of claim 2, wherein
the first electrode driver includes a drive IC connected to the first electrode and a switch supplying a scan pulse falling a fourth voltage during an address period through the drive IC.

8. The plasma display apparatus of claim 2, wherein
the first electrode driver includes a drive IC connected to the first electrode, a switch connected to one terminal of the drive IC, a second voltage source, which is connected to the other terminal of the drive IC and the switch, supplying the second voltage, a first ground switch connected to the one terminal of the drive IC and a ground, and a second ground switch connected to the other terminal of the drive IC and the ground.

9. The plasma display apparatus of claim 8, wherein
the switch operates in an active region during a reset period, and
the drive IC supplies a pulse gradually rising from a ground level voltage to the second voltage to the first electrode when the second ground switch is turned on.

10. The plasma display apparatus of claim 8, wherein
the switch operates in an active region during a reset period, and
the drive IC supplies a pulse falling from a ground level voltage to the first electrode when the first ground switch is turned on.

11. The plasma display apparatus of claim 8, wherein
“the switch operates in an saturation region during an address period, and
the drive IC supplies a scan pulse falling to the second voltage to the first electrode when the first ground switch is turned on.

12. The plasma display apparatus of claim 1, wherein
the driver includes a first electrode driver supplying to the first electrode the first pulse rising from a reference voltage to the second voltage during the reset period, and the reference voltage during the sustain period, and a second electrode driver supplying to the second electrode the second pulse gradually falling from the reference voltage to the first voltage and the sustain pulse during the sustain period.

13. The plasma display apparatus of claim 12, wherein
the first electrode driver includes a drive IC, a second voltage source connected to the drive IC and supplying the second voltage, and a switch, which is connected to the second voltage source, supplying the first pulse and the reference voltage at the time of a supply of the sustain pulse.

14. The plasma display apparatus of claim 12, wherein
the first electrode driver includes a drive IC connected to the first electrode and a switch supplying a third pulse gradually falling to a third voltage during the reset period through the drive IC.

15. The plasma display apparatus of claim 12, wherein
the first electrode driver includes a drive IC connected to the first electrode, and a switch supplying a scan pulse falling to a fourth voltage during an address period.

16. The plasma display apparatus of claim 12, wherein
the first electrode driver includes a drive IC connected to the first electrode, a second voltage source, which is connected to the drive IC, supplying the second voltage, a fourth voltage source supplying a fourth voltage, and a switch supplying a sum of the second voltage and the fourth voltage during an address period through the drive IC.

17. A driving method of a plasma display apparatus including a first electrode and a second electrode, comprising:
making a voltage difference between the first electrode and the second electrode gradually rise from a magnitude of a first voltage to a sum of magnitudes of the first voltage and a second voltage by supplying a first pulse and a second pulse respectively to the first electrode and the second electrode during a reset period; and
supplying a sustain pulse swinging from a positive sustain voltage to a negative sustain voltage during a sustain period.

18. The driving method of a plasma display apparatus of claim 17, wherein
the first pulse, which gradually rises from a reference voltage to the second voltage, is supplied to the first electrode,
the reference voltage is supplied to the first electrode during the sustain electrode, and
the second pulse, which falls from the reference voltage to the first voltage, is supplied to the second electrode.

19. The driving method of a plasma display apparatus of claim 17, wherein
the first pulse, which rises from a reference voltage to the first voltage, is supplied to the first electrode,
the reference voltage is supplied to the first electrode during the sustain period, and
the second pulse, which gradually falls from the reference voltage to the first voltage, is supplied to the second electrode.
